(19) United States
(12) Patent Application Publication
(10) Pub. No.: US 2010/0063377 A1
(43) Pub. Date: Mar. 11, 2010

(54) BLUETOOTH SYSTEM AND METHOD FOR DETERMINING AND STORING A DENTAL ROOT CANAL DEPTH MEASUREMENT

(75) Inventors: Arik Becker, Kibbutz Afikim- Doar-Na Emwk HaYarden (IL); Gabridel Savin, Kibbutz Afikim- Doar-Na Emwk HaYarden (IL); Haim Rozenboim, Natania (IL)

Correspondence Address: MARTIN D. MOYNIHAN d/b/a PRTSI, INC., P.O. BOX 16446, ARLINGTON, VA, 22215, US

(73) Assignee: MedicN.R.G. Ltd., Kibbutz Afikim-Doar-Na Emek Ha Yarden (IL)

(21) Appl. No.: 12/525,856

(22) PCT Filed: Feb. 5, 2008
(86) PCT No.: PCT/IL08/00151

§ 371 Date: Nov. 17, 2009

(51) Int. Cl. A61C 19/04; H04B 7/00

(52) U.S. Cl. 600/407; 455/41.3

(57) ABSTRACT

A system for determining and storing a dental root canal depth measurement comprising: at least one electronic apex locator configured to locate the apex of a dental root canal; a dental instrument configured to be inserted into the dental root canal, up to the apex thereof; and a remotely located data storage unit configured to store data concerning the root canal apex. Data concerning the apex of the root canal may be transmitted from the apex locator to the data storage unit via Bluetooth transmission and may be exhibited on a display, along with the depth measurement of the root canal and a digital x-ray showing the location of the dental instrument in the root canal.

### FIELD AND BACKGROUND OF THE INVENTION

The present invention relates to a dental root measuring system and, more particularly, to a system and method for determining and storing a dental root canal depth measurement.

### BACKGROUND OF THE INVENTION

There are known in the art a number of dental probes, such as a reamer or a file, each of which may be inserted into a dental root canal and manipulated to remove undesired material. The canal is then filled with a flexible filler substance and is then sealed with a rigid material. If the canal is not completely cleaned prior to filling and sealing, debris left inside the canal can prevent proper healing. The probe must, therefore, be inserted all the way to the apex of the root canal during cleaning, in order to remove all debris. If, however, the probe is inserted too deep, past the apex of the root canal, it penetrates the jaw tissue, causing swelling and unnecessary trauma for the patient. It is, therefore, essential to precisely determine when the probe tip has reached the root canal apex, so that the canal can be cleaned fully, without excessive trauma to the patient.

Locating the apex of the root canal can be difficult, because the narrow canal does not provide a clear viewing path and fluids such as blood or saliva can partially fill the canal. Additionally, the shape of a root canal may be winding, making it even more difficult to see the end of the canal.

It is known in the art to insert a metal probe into a root canal and then to x-ray the tooth. In the x-ray image, the metal probe contrasts with the surrounding tooth and body tissue, so that the positions of the probe tip and the apex can be compared. If the probe tip is not at the apex, it is inserted further into the root canal and a new x-ray image is obtained. This method is unreliable, since the location of the apex of a root canal can vary from 0.25 to 4.0 millimeters, as seen in x-ray images, thus resulting in a final root canal treatment that is either too short or too long. Additionally, this method is time-consuming and costly, and exposes the patient to unnecessary x-ray radiation.

Other methods for locating a root canal apex, disclosed in several US patents, employ a conductive probe which is inserted into the root canal. An electrode is placed in contact with the body of the patient, usually in or near the mouth. As the probe is moved through the root canal towards the apex thereof, electrical measurement across the probe and electrode are made.

For example, U.S. Pat. No. 5,080,586 discloses a device for locating a dental root canal apex by measuring a change in impedance between a measuring needle inserted into the root canal and an electrode abutting an oral mucosa. Two kinds of frequency signals are generated, and a change in the impedance in response to the frequencies is detected as the needle is moved towards the apex of the root canal. A detector determines the positioning of the needle at the root canal apex when the difference between the two impedance measurements is within a predetermined range.

U.S. Pat. No. 5,096,419 discloses a device which makes impedance measurements by driving two fixed frequencies and fixed amplitude sinus shaped currents as a probe is moved towards the apex of a dental root canal. A detector determines the positioning of the probe at the root canal apex when the ratio of the two impedance measurements is within a predetermined range.

U.S. Pat. No. 6,425,875 discloses a device wherein a probe tip is inserted into a dental root canal and impedance measurements are taken by driving two fixed frequencies and fixed amplitude sinus shaped currents as the probe is moved towards the apex of the root canal. Two regions, A and B are defined. A detector determines the positioning of the probe tip according to the difference between the impedance measurements, at region A. At region B, the ratio of the two impedance measurements defines the location of the probe tip.

The methods discussed above which provide impedance measurements are affected by applying a continuous sinus-shaped current at one or more frequencies to the tissue of a patient. Due to the fact that current is limited by regulation and patient comfort, the current must be restricted, thus limiting the accuracy of such methods.

There is thus a widely recognized need for, and it would be highly advantageous to have, a system and method for accurate measurement of a dental root canal, devoid of the above limitations. Additionally, there is a need for a system and method for determining and storing a dental root canal depth measurement, such that such measurements may be retrieved at a later date. Previously, the only way to document a root canal procedure and to compile relevant information was via manual patient files or the dentist's memory. Since there are usually 1-5 canals in a single tooth, it is likely that an error will be made if the documentation is done manually, as is common practice according to known methods. Further, there is a need for a system and method for a dedicated software system that stores data concerning a plurality of dental root canals including depth measurements.

### SUMMARY OF THE INVENTION

According to one aspect of the present invention there is provided a system for determining and storing a dental root canal depth measurement comprising: at least one electronic apex locator configured to locate the apex of a dental root canal; a dental instrument, associated with each of the at least one electronic apex locator, configured to be inserted into the dental root canal, up to the apex thereof; and a remotely located data storage unit configured for storing data concerning at least one dental root canal, the apex locator configured to transmit data concerning the dental root canal to the data storage unit. According to another aspect of the present invention the system comprises a display configured to exhibit data concerning the dental root canal.

According to still another aspect of the present invention the exhibited data includes the distance of a leading edge of the dental instrument from the root canal apex.

According to yet another aspect of the present invention the exhibited data includes the dental root canal depth measurement.

According to yet a further aspect of the present invention the dental instrument is provided with a marker configured to mark the depth of the root canal along the dental instrument.

According to another aspect of the present invention the marked dental instrument is configured to facilitate the suitability for a root canal treatment of a plurality of additional dental instruments having different thicknesses.

According to still another aspect of the present invention the system comprises a measuring device configured to determine the depth measurement of the dental root canal based on the marked dental instrument.

According to yet another aspect of the present invention the depth measurement is determined based on a measurement of the marked dental instrument.

According to yet a further aspect of the present invention the data storage unit is provided with an input device configured for receiving and storing data regarding the depth measurement.

According to another aspect of the present invention the input device is chosen from the group consisting of: a keyboard and a mouse.

According to still another aspect of the present invention the apex locator includes a transmission unit configured for transmitting data concerning the dental root canal to the data storage unit.

According to yet another aspect of the present invention the data transmitted from the apex locator to the data storage unit includes a measurement of the distance between a leading edge of the dental instrument and the apex of the root canal.

According to yet a further aspect of the present invention the data transmitted from the apex locator to the data storage unit includes data concerning the physical condition of the interior of the root canal.

According to another aspect of the present invention the transmission unit is a wireless transmission unit.

According to still another aspect of the present invention the transmission unit is a Bluetooth® transmission unit configured for transmitting the location of a leading edge of the dental instrument.

According to yet another aspect of the present invention the apex locator is selected from the group consisting of an analog computerized unit and a digitally computerized unit.

According to yet a further aspect of the present invention the apex locator is configured to be operated proximal to the mouth of a patient.

According to another aspect of the present invention the apex locator is provided with an indicator configured to indicate the distance between a leading edge of the dental instrument and the apex of the root canal.

According to still another aspect of the present invention the indicator is chosen from the group consisting of: a plurality of LEDs and an LCD display.

According to yet another aspect of the present invention the apex locator is provided with an alarm configured to sound an alarm when a leading edge of the dental instrument is located at the apex of the dental root canal.

According to yet another aspect of the present invention apex locator comprises: a software operated microcontroller having a pulse generator and a memory, the pulse generator being configured to feed pulses to a gain control circuit for controlling the amplitude of the pulses; and a driver configured to receive signals from the control circuit and to feed the signals to an electrically conductive shaft and a dental instrument having a leading edge.

According to yet a further aspect of the present invention the apex locator comprises: a software operated microcontroller having a pulse generator, a memory and an analog to digital converter (ADC), the pulse generator being configured to feed pulses to a gain control circuit for controlling the amplitude of the pulses; a driver configured to receive signals from the control circuit and to feed the signals to an electrically conductive shaft and a dental instrument having a leading edge; and an input buffer configured to receive signals from the dental instrument and to feed the signals to the ADC, wherein the signals are converted to digital signals.

According to another aspect of the present invention the pulse generator is configured to produce micro-electrical signals at multiple frequencies and to send the signals through the dental instrument to the end of the root canal.

According to still another aspect of the present invention the microcontroller is configured to process the output of the multiple frequencies to determine the distance between a leading edge of the dental instrument and the apex of the root canal.

According to yet another aspect of the present invention the distance determined is accurate to substantially 0.1 mm.

According to yet a further aspect of the present invention the apex locator is configured to determine the physical condition of the interior of the dental root canal.

According to another aspect of the present invention the apex locator is configured to determine the physical condition of the interior of the dental root canal based on a measure of the humidity therein.

According to still another aspect of the present invention the system further comprises a display configured to exhibit data concerning the dental root canal, the display provided with an LED and a signal device; and the system is configured to light up the LED and to sound the signal device when the difference in humidity between the physical condition of the dental root canal at a first portion thereof and the physical condition of the root canal at a second portion thereof is greater than a predetermined amount.

According to yet another aspect of the present invention the microcontroller is configured to automatically adjust the impedance of current transmitted via the dental instrument such that it corresponds to the physical condition of the interior of the dental root canal.

According to yet another aspect of the present invention the gain control circuit is configured to maintain the signals at a constant signal to noise ratio.

According to still another aspect of the present invention the pulses are substantially square pulses.

According to yet a further aspect of the present invention the system further comprises a filter configured to filter the signals transmitted from the dental instrument to the ADC.

According to another aspect of the present invention the microcontroller is configured to calculate the average of the majority of signals received.

According to another aspect of the present invention the system further comprises a contact element configured to contact the tissue of a patient, the contact element configured to transmit the signals from the dental instrument to the microcontroller.

According to still another aspect of the present invention the contact element is configured to contact the lip of the patient.

According to yet another aspect of the present invention there is provided a method for determining and storing a dental root canal depth measurement comprising: (a) providing a dental instrument having a leading edge; (b) inserting the dental instrument into the beginning of the root canal; (c) transmitting a pulsed signal from the dental instrument, via the root canal, to the apex of the root canal; (d) converting the pulsed signal to a signal indicative of the distance between a leading edge of the dental instrument and the apex of the root canal; (e) if the digital signal indicates that the leading edge of the dental instrument has reached the apex of the root canal then proceeding to step (g), otherwise proceeding to step (f); (f) inserting the dental instrument further into the root canal and returning to step (c); (g) marking the dental instrument at the point therealong which is at the entrance to the root canal; (h) measuring the distance between the marked point and the leading edge of the dental instrument to determine the depth of the root canal; and (i) storing the root canal depth measurement.

According to yet another aspect of the present invention in step (d) the pulsed signal is converted to an analog signal

According to yet another aspect of the present invention in step (d) the pulsed signal is converted to a digital signal.

According to yet another aspect of the present invention the method comprises the following steps in between steps (b) and (c): providing an apex locator comprising: a software operated microcontroller having a pulse generator and a memory, the pulse generator configured to feed pulses to a gain control circuit for controlling the amplitude of the pulses; a driver configured to receive signals from the control circuit and to feed the signals to an electrically conductive shaft; and an input buffer configured to receive signals from the dental instrument, wherein the signals are converted to digital signals indicative of the distance between the leading edge of the dental instrument and the apex of the root canal; and providing a data storage unit configured to store data regarding the distance between the leading edge of the dental instrument and the apex of the root canal, wherein the data is transmitted from the apex locator to the data storage unit.

According to yet another aspect of the present invention the method further comprises the following steps in between steps (b) and (c): providing an apex locator comprising: a software operated microcontroller having a pulse generator, a memory and an analog to digital converter (ADC), the pulse generator configured to feed pulses to a gain control circuit for controlling the amplitude of the pulses; a driver configured to receive signals from the control circuit and to feed the signals to an electrically conductive shaft; and an input buffer configured to receive signals from the dental instrument and to feed the signals to the ADC, wherein the signals are converted to digital signals indicative of the distance between the leading edge of the dental instrument and the apex of the root canal; and providing a data storage unit configured to store data regarding the distance between the leading edge of the dental instrument and the apex of the root canal, wherein the data is transmitted from the apex locator to the data storage unit.

According to yet a further aspect of the present invention step (c) further comprises transmitting the pulsed signal from the root canal apex to the input buffer.

According to yet a further aspect of the present invention step (c) of the method further comprises transmitting the pulsed signal from the root canal apex to the input buffer and to the ADC.

According to another aspect of the present invention step (d) of the method further comprises storing the distance between the leading edge of the dental instrument and the apex of the root canal in the microcontroller memory.

According to still another aspect of the present invention step of the method (i) comprises storing the root canal depth measurement on the data storage unit.

According to yet another aspect of the present invention the pulsed signal comprises a plurality of waves wherein the length of the waves shortens as the leading edge of the dental instrument approaches the apex of the root canal.

The present invention successfully addresses the shortcomings of the presently known devices by providing a system and method whereby accurate measurement of a dental root canal and storage of such measurement is achieved, with minimal discomfort to the patient. The system and method in accordance with the present invention provide an improved signal to noise ratio when compared with known devices, thus yielding more accurate results. The system and method in accordance with the present invention also provides a data storage unit which stores data concerning a plurality of dental root canals including depth measurements.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, a determination may be made in accordance with the patent specification, including definitions. In addition, the materials, methods, and examples are illustrative only and are not intended to be limiting.

Implementation of the system and method of the present invention involves performing or completing selected tasks or steps manually, automatically, or a combination thereof. Moreover, according to actual instrumentation and equipment of preferred embodiments of the system and method of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a data storage unit using any suitable operating system. In any case, selected steps of the system and method of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is an illustration of a system for determining and storing a dental root canal depth measurement in accordance with an embodiment of the present invention;

FIG. 2 is an illustration of an apex locator device for use in accordance with an embodiment of the system of the present invention;

FIG. 3 is an illustration of an apex locator device, according to an embodiment of the present invention, when employed by a dentist on a patient;

FIG. 4 is a block diagram of an embodiment of an apex locator device in accordance with the present invention;

FIG. 5 is a schematic illustration of the pulses generated by the apex locator device of FIG. 1, in comparison with pulses of prior art devices;

FIG. 6 is an exemplary illustration of a computer display which may be generated in accordance with an embodiment of the system of the present invention;

FIG. 7 is a flowchart of a method for determining and storing a dental root canal depth measurement in accordance with an embodiment of the present invention; and

FIG. 8 is an exemplary illustration of an additional computer display which may be generated in accordance with an embodiment of the system of the present invention.

### DESCRIPTION OF THE PREFERRED EMBODIMENTS

The present invention is of a system and method for determining and storing a dental root canal depth measurement. The principles and operation of a system and method for determining and storing a dental root canal depth measurement according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

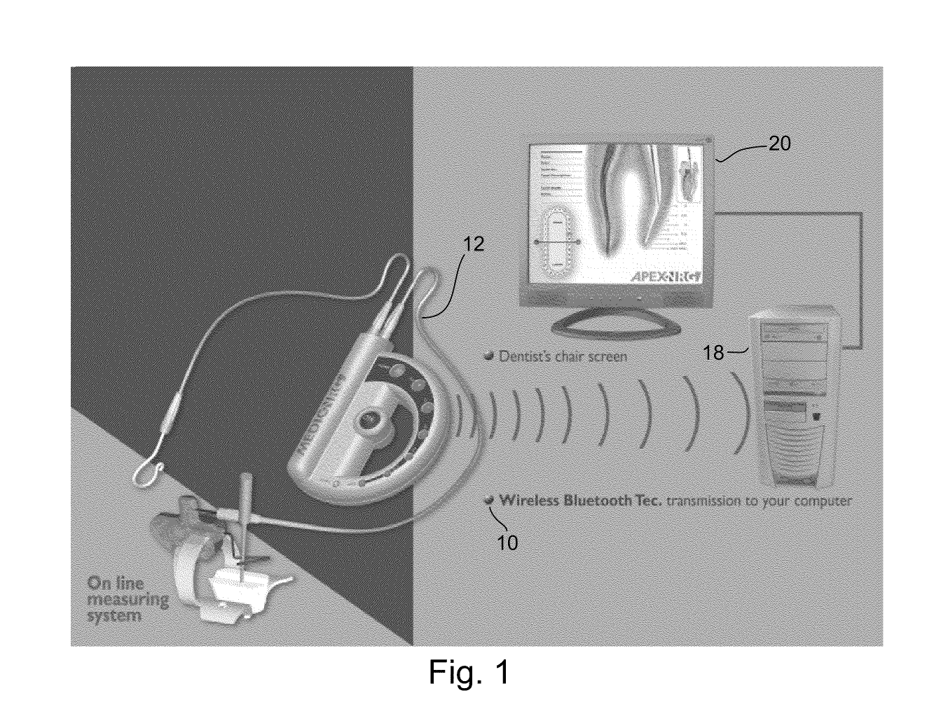

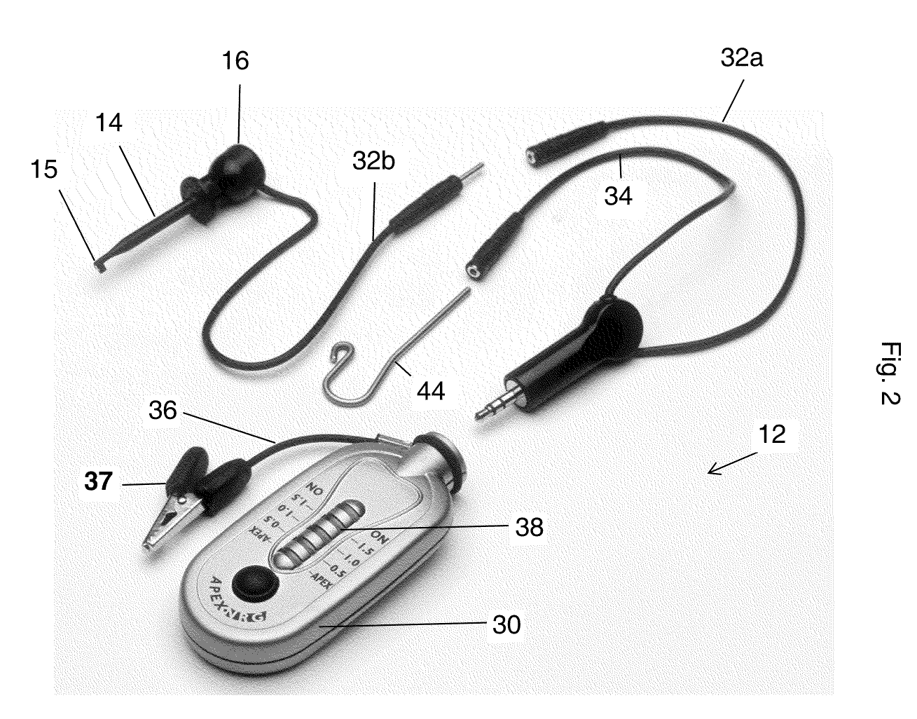

Referring now to the drawings, FIG. 1 is an illustration of a system 10 for determining and storing a dental root canal depth measurement in accordance with an embodiment of the present invention. System 10 includes an electronic apex locator device 12 for locating the apex of a dental root canal. The operation and function of apex locator device 12 will be discussed hereinbelow. System 10 further includes a dental instrument 14, such as a dental file, which is to be inserted into the dental root canal, up to the apex thereof, and a file holder 16, which connects the dental instrument 14 to the unit 30 (FIG. 2) of the apex locator device 12 via cables 32b and 32a.

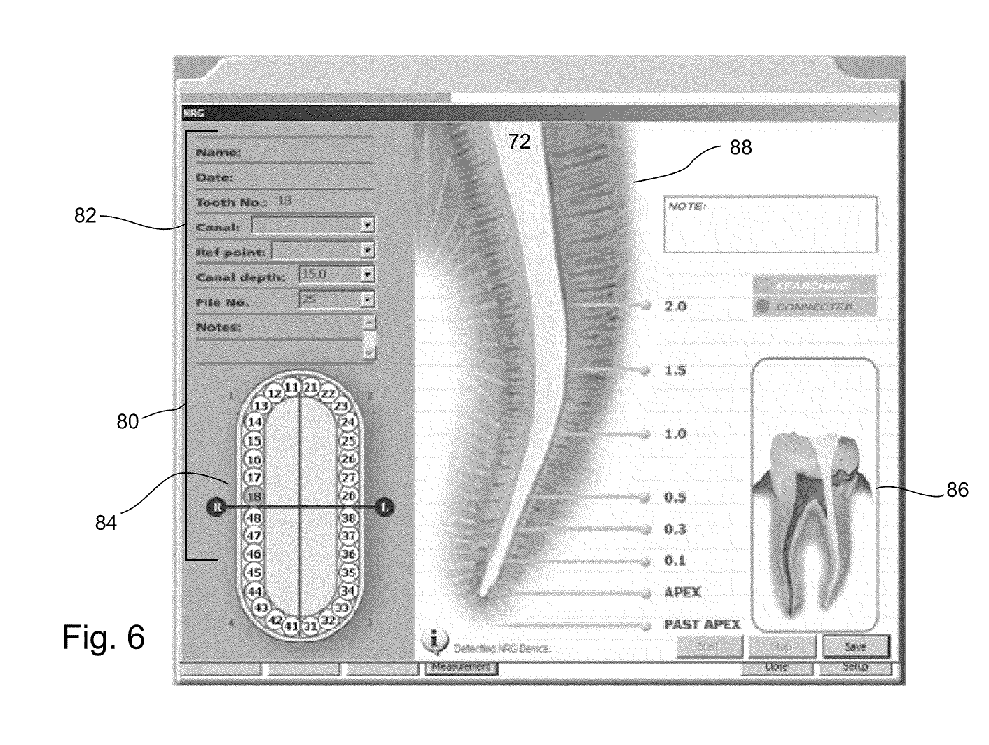

System 10 is additionally provided with a remote data storage unit 18 having an input device (not shown), such as a keyboard or a mouse, and a display 20 on which data concerning the dental root canal may be exhibited. This will be discussed further below, with reference to FIG. 6.

Apex locator device 12 includes a transmission unit (not shown) for transmitting data concerning the dental root canal to the remote data storage unit 18, where it may be stored and retrieved at a later date. As will be discussed below, the data transmitted may be, for example, the distance between a leading edge 15 of the dental instrument 14 and the apex of the root canal or an indication of the physical condition within the root canal. Preferably, the transmission unit is a wireless transmission unit and, more preferably, the transmission unit is a Bluetooth® transmission unit.

Once the leading edge 15 of the dental instrument 14 has been inserted into the dental root canal, up to the apex thereof, it is marked at the point along the dental instrument which is at the beginning of the root canal. The dental instrument may then be removed from the root canal, and the depth measurement of the root canal is determined by manually measuring the distance between the leading edge 15 and the marked point. The depth measurement may then be input by the dentist into the data storage unit, and this data may be exhibited on the display, as noted above.

The depth measurement may be utilized to facilitate the suitability of a plurality of additional dental instruments, having different thicknesses, which may be employed in the treatment of the measured root canal. For example, a treatment such as clearing a dental root canal of debris often requires a number of files having varying thicknesses. After the thinnest file is used to clear the root canal, a thicker one may be used, etc., until all debris is removed from the root canal. Thus, once a first dental instrument has been measured and marked, other, successively thicker dental instruments may be measured and marked by comparison with the first dental instrument, after which they may be successively utilized in a dental root canal treatment.

With additional reference to FIG. 2, apex locator device 12 includes a digitally computerized unit 30 which is of a size and configuration so as to be easily operated by a dentist. Alternatively, unit 30 may be an analog unit. The apex locator device 12 is specifically designed to be operated proximal to the mouth of a patient. Device 12 includes cables 32a,b and 34 which are attached to unit 30. As noted above, cables 32a,b connect unit 30 to a dental instrument 14, whose function will be discussed below. Cable 34 connects unit 30 to a lip hook 44, which functions as an electrode. Lip hook 44 is preferably formed of stainless steel, and functions as will be discussed below. Apex locator device 12 is provided with an optional clip 38 and wire 36, for fastening unit 30 to a bib or other element of clothing of the patient.

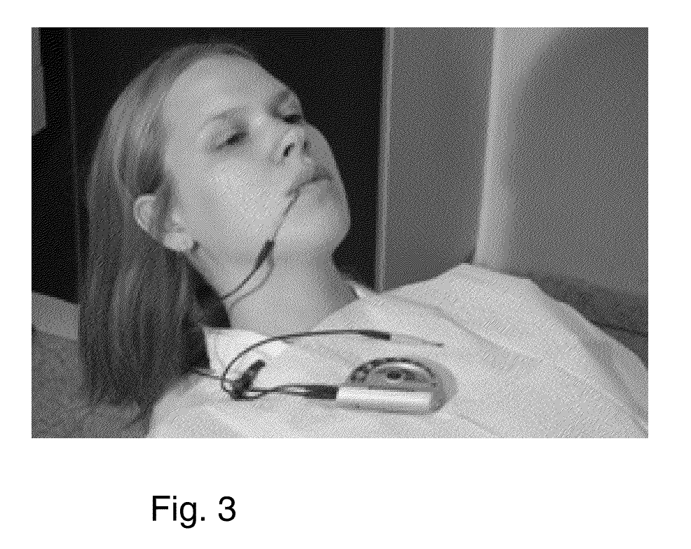

It should be noted that cables 32a,b and 34 are lightweight and are approximately 80% shorter than cables provided in other devices, thereby preventing external influences and distortions that can occur in weak and sensitive signals. Also, during operation, apex locator device 12 is preferably placed in the field of vision of the dentist, near the patient's mouth, as shown in FIG. 3. In this manner, the dentist may follow on-line the progress of the dental instrument as it travels into the root canal. Further, short cables prevent exposure to electromagnetic interference, such as from cellular phones, thus providing another advantage of the present invention over known devices. Yet further, the provision of short, lightweight cables enhances comfort and stability during measurement of the root canal. The apex locator device 12 is itself a compact, lightweight instrument, weighing only 30 grams and, thus, is easy to manipulate during operation and is easy to store when not in use.

If desired, cables 32a and 32b may be replaced by a single cable leading from unit 30 to dental instrument 14. As illustrated in FIG. 2, cables 32a,b and 34 and unit 30 are separate components which may be easily fastened together or separated, as desired. In accordance with another embodiment (not shown) of the present invention, the apex locator device may include a unit and cables which are permanently attached.

Apex locator device 12 is provided with an indicator 38 for indicating the distance between a leading edge of the dental instrument and the apex of the root canal. The indicator 38 may include a plurality of LEDs, as shown, with corresponding printed measurement values, such as every half millimeter, wherein a particular LED lights up in response to the leading edge 15 of the dental instrument 14 reaching a depth of the dental root canal having a corresponding measurement value. Alternatively, indicator 38 may include a display, such as an LCD, wherein the distance between the leading edge of the dental instrument and the apex of the root canal may be displayed digitally.

Apex locator device 12 is provided with an alarm (not shown) configured to sound an alarm when the leading edge 15 of the dental instrument 14 is located at the apex of the dental root canal.

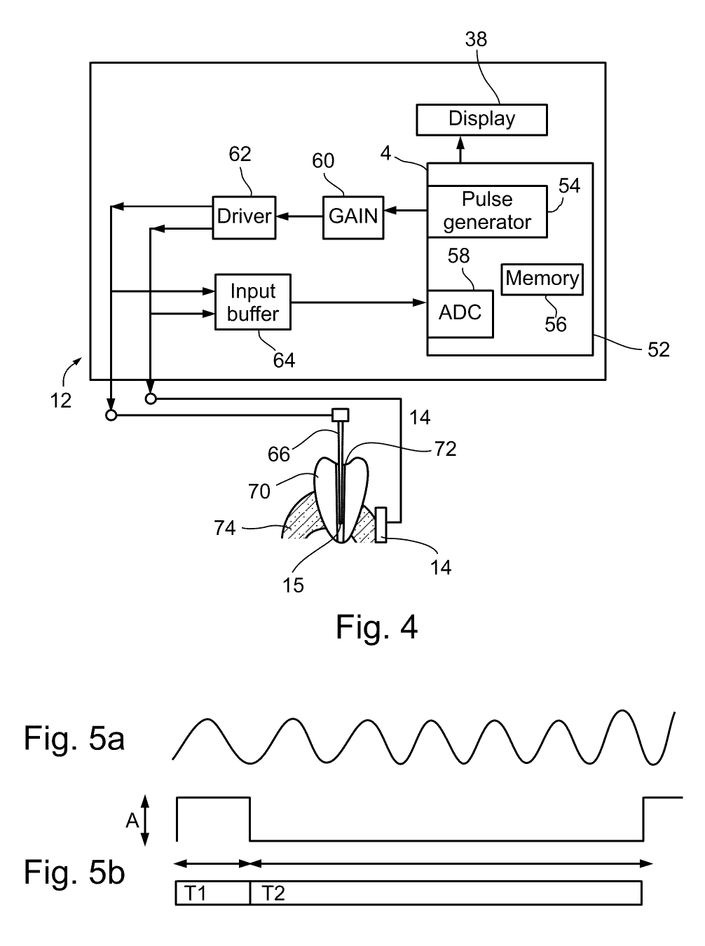

With additional reference to FIG. 4, unit 30 of apex locator device 12 is provided with a software operated microcontroller 52 having a pulse generator 54, a memory 56 and an analog to digital converter (ADC) 58. The pulse generator 54 feeds pulses to a gain control circuit 60 for controlling the amplitude of the pulses. The gain control circuit maintains the signals transmitted at a constant signal to noise ratio. The pulses generated are substantially square pulses. Alternatively, microcontroller 52 may feed analog pulses to gain control circuit 60.

A driver 62 receives signals from the gain control circuit 60 and feeds the signals to an electrically conductive shaft 66 of dental instrument 14, thus driving the dental instrument 14 into the canal 72. Unit 30 is further provided with an input buffer 64 for receiving signals from the dental instrument 14 and feeding the signals to the ADC 58, wherein the analog signals are converted to digital signals An indicator 38 is connected to the microcontroller 52 and is operated thereby. If no ADC is utilized, as noted above, microcontroller 52 is operated by analog signals.

The signals produced by the apex locator device 12 are transmitted through shaft 66 of dental instrument 14, towards the patient's gum tissue 74 (FIG. 4) located at the apex of the root canal 72. The pulse generator 54 produces micro-electrical signals at multiple frequencies and sends these signals through dental instrument 14 to the end of the root canal 72, up to the location of gum tissue 74 in which the tooth 70 is located. In operation of apex locator device 12, a plurality of test pulses are sent through dental instrument 14 and the power of each pulse is calculated to determine a medial estimated reference power. The location of the leading edge 15 of the dental instrument 14 relative to the apex of the root canal is determined by means of precalculated data pairs exhibiting the distance between the leading edge 15 and the apex and the estimated reference power. Thus, the microcontroller 52 processes the output of the multiple frequencies to determine the distance between the leading edge 15 of the dental instrument 14 and the apex of the root canal 72. In this manner, the distance determined is reliable and is accurate to substantially 0.1 mm, which is a significant improvement over the accuracy of known devices.

A unique feature of the apex locator device 12 is that it is able to measure the humidity within the dental root canal, and is thus able to determine the condition present therewithin, such as dry, wet, or bleeding, which may indicate an inflammation or infection in the region of the root canal. Additionally, during operation, the apex locator device 12 is able to detect differences in humidity among different portions of the root canal. Thus, for example, if the apex locator device 12 at first detects a dry condition along most of the root canal and then detects humidity at the root canal apex, this indicates that an infection is developing in the area of the root canal apex. In order for a dentist operating the system 10 to more easily detect such a developing infection, the display 20 is provided with an LED (not shown) which lights up and with a signal device (not shown) which sounds when the difference in humidity between the physical condition of the dental root canal at a first portion thereof and the physical condition of the root canal at a second portion thereof is greater than a predetermined amount, thus indicating the that a developing infection has been detected.

This is especially important information for the dentist, since it is desirable that any infection present within the vicinity of the dental root canal be completely healed before the root canal is permanently filled. The apex locator device 12 thus enables the dentist to avoid treatment of a patient by permanently filling a root canal while there is still some infection therein, which would then result in further inflammation and discomfort for the patient. Instead, the dentist may decide to administer an antibiotic treatment directly into the root canal and apply a temporary filling thereto, thereby enabling the infection to heal before the root canal is permanently filled. At a later date to be decided by the dentist, the condition of the root canal may be determined again and, if no infection is detected, the root canal may be permanently filled. Alternatively, if desired, the dentist may postpone all treatment until the infection has completely healed. In any event, the dentist may combine the findings of the apex locator device 12 with those of dental x-rays so as to decide on the most appropriate treatment for the patient.

As noted above, based on the canal condition, the apex locator device 12 is able to determine whether an infection is present within the root canal. Once the condition within the canal is determined, the microcontroller 52 automatically adjusts the impedance of the current transmitted via dental instrument 14 such that it corresponds to the particular condition present in the dental root canal 72.

It should be noted that, regardless of the condition of a dental root canal, i.e., dry, wet, or bleeding, other measuring devices employ a single measuring current which is chosen for an average of canal conditions. In contrast, the present invention is able to adjust the impedance of the measuring current based on the root canal condition, such that it corresponds thereto, thus providing much greater accuracy than can be achieved with known root canal measuring devices.

Additionally, it may be noted that signals transmitted from dental instrument 14 to the ADC 58 are filtered along the cable 34, thus eliminating the exception signals that are produced in winding canals or under other extraordinary circumstances where distortions may result. Thus, only the average of the majority of signals received is calculated.

Signals are transmitted from the leading edge 15 of dental instrument 14, through the root canal 72, and via lip hook 44 and cable 34, back to microcontroller 52. It may be noted that lip hook 44 is a convenient embodiment of a contact element for transmitting signals from the dental instrument 14 to microcontroller 52, as it may be easily fitted onto the lip of the patient, as shown in FIG. 3. Alternatively, if desired, any other suitable contact element may be employed.

Referring now to FIG. 5, there is shown a schematic illustration of the pulses generated by the apex locator device in accordance with the present invention, in comparison with pulses of prior art devices which employ impedance measurements, such as discussed above.

At (a), there is shown a continuous sine wave (single frequency) and at (b) there is shown a square wave (multiple frequency, such as employed in the present invention) or a substantially square wave pulse, both extending over an active period of time T1 and a non-active period of time T2. In the case of continuous sinus signal, for example, the power is calculated as P=A/1.44, where A is the current amplitude. In the case of individual pulses such as, for example, square pulses, the power is calculated as P=A*T1/(T1+T2). If the current amplitude of the wave is given as A=10 microamperes, T1 is given as 10 microseconds and T2 is given as 90 microseconds then, for a continuous sinus signal, the power may be calculated as P=10/1.44=approximately 7 microamperes and, for a non-continuous pulse, the power may be calculated as P=10*10/(10+90)=1 microampere. Thus, the use of non-continuous pulses in accordance with the present invention reduces the current dramatically and can increase the measurement accuracy.

In operation of the present invention, the microcontroller 52 sends to the pulse generator 54 a short period pulse of active time T1. The non-active time between two consecutive pulses T1 is a time period T2. The microcontroller 52 also optionally controls a variable output amplitude by the gain control 12. During the time the microcontroller 4 drives the dental instrument 14 into the canal, the ADC continuously sends N pulses and samples M points along the canal 72 and stores signals in the microcontroller's memory 56. The microcontroller 52 uses the data located in its memory 56 to calculate and determine the position of the leading edge 15 of the dental instrument 14, relative to the apex of the canal, updates the information and displays it on the indicator 38. In order to select the proper gain of the pulse generated by the pulse generator 54, the software actuates a test pulse of an active time DT1, which may be, for example, 760 microseconds and, by using digital filters, in the case of digital signals, calculates the power of the signal [P=function (data in, M, DT1)], where “data in,” “M,” and “DT1” refer to the input data vector, number of sampling points, and pulse active time, respectively. The software effects the selection of the drive current gain according to a list of thresholds stored in the program. This gain will be set for each measurement cycle. Using the adaptive gain, the apex locator device 12 keeps a constant signal to noise ratio, regardless of the environment of the root canal, i.e., dry canal, wet canal, etc. The software drives the pulse DT1 at a specific gain for an active time T1 and calculates the power of the signal and stores it in a memory location designated P1. Subsequently, the software drives pulse DT2 and calculates the power of the signal and stores it in a memory at a location designated P2. Based on the power measurements performed at, e.g., DT1 and DT2, an average, mean, or any other selected medial estimate power is calculated. This calculated power is referred to as the REF power, which is read against the location of the leading edge 15 of the dental instrument 14 in the canal 72 in a Look-Up Table (LUT). The LUT is generated according to laboratory and clinical tests previously performed. The LUT determines the location of the leading edge 15 relative to the apex of the canal 72, by means of precalculated data pairs exhibiting the distance between the leading edge 15 and the apex of canal 72 and the REF power. The software then updates the function and displays it on the indicator 38 and then starts a new cycle. In this manner, in accordance with the present invention, the measuring current is automatically adjusted, regardless of the environment within the canal 72, whether dry, wet, or bleeding.

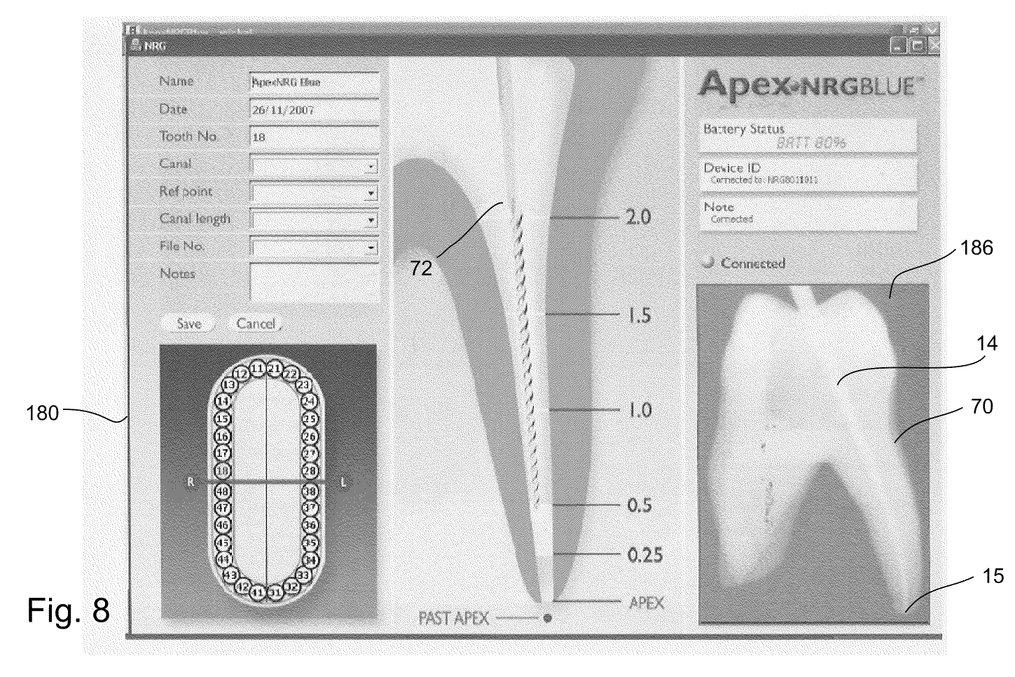

FIG. 6 is an exemplary illustration of a computer display 80 which may be generated in accordance with an embodiment of the system of the present invention. The display may be designed to appear as a patient file, having a portion 82 including relevant patient data such as, for example, patient name, date of measurement, and depth of root canal, as well as a schematic illustration 84 of the patient's teeth, including a tooth number which defines the location of the tooth within the patient's mouth. The display 80 may also include an image 86 of a tooth and an image 88 of the dental root canal with measurement values corresponding to the depth of the root canal. The display may include an x-ray image 186 of a patient's tooth, taken by a digital x-ray system, as shown in computer display 180 of FIG. 8. Display 180 shows the exact location of the dental instrument 14 in the root canal 72. It can be seen in this x-ray image that leading edge 15 of dental instrument 14 is at the apex of the root canal 72 in tooth 70. This provides an improvement over existing systems, which may show an image 88 (as in FIG. 6) representing the advancement of a dental instrument in a root canal, not the advancement of a dental instrument in the actual root canal of a patient. If desired, the dentist may open additional windows on the display 180 in order to input and store additional data related to the root canal of the patient. Such additional data may include the type of root canal; canal status (wet, dry, or bleeding), which may indicate an inflammation or infection in the region of the root canal apex; type and size of last dental instrument, such as a file, utilized in treatment; and the reference point along the file from which the measurement of the file length was taken. The size of the file or other dental instrument utilized in a root canal treatment is important information for the apex locator device 12, which will then self-calibrate the measuring current and optimize accuracy of any future measurement. The size and diameter of the file thus have an impact on the impedance and the conduction of the electrical signals.

When employing the system in accordance with the present invention, while the dentist is observing the progress of the dental instrument 14 into the root canal 72, he may direct the attention of his patient to image 88 on the display 80, thus keeping the patient informed as to the depth at which the leading edge 15 of the dental instrument 14 has reached, as it travels further into the root canal.

If desired, the display 80 may be a computer screen installed on the patient's treatment chair or on the dentist's instrument table. The screen may be connected through the data storage unit 18 (FIG. 1) to a digital x-ray system or clinic management system; a laptop computer screen; a palm computer screen; a cellular phone screen (3^{rd} generation), or any other suitable display screen, in which case display 180 will be shown.

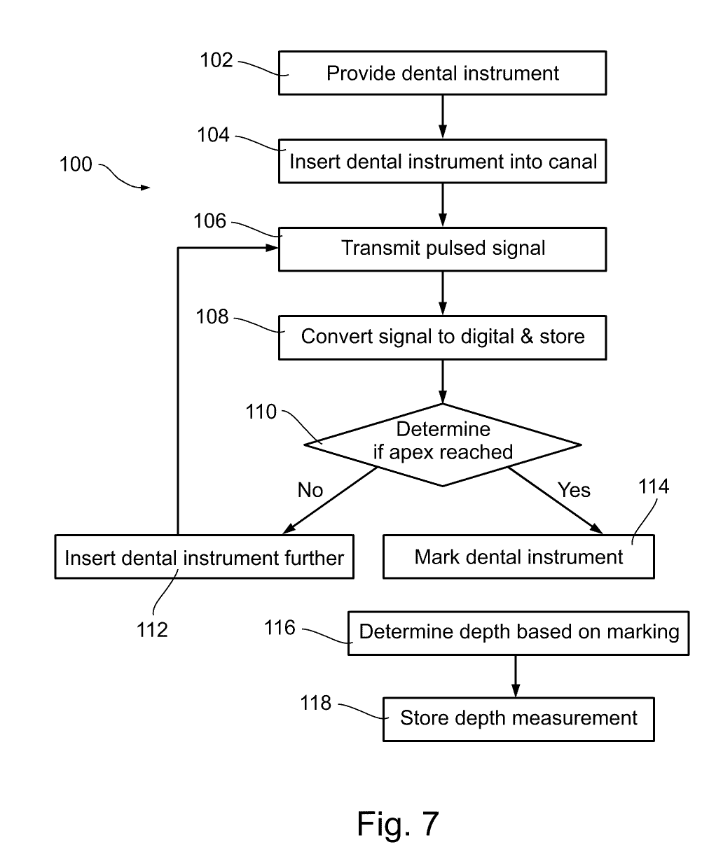

With reference to FIG. 7, there is shown a flow chart of a method 100 for determining and storing a dental root canal depth measurement in accordance with the present invention. Method 100 begins a step 102, at which there is provided a dental instrument having a leading edge. The dental instrument is inserted into the beginning of a root canal, as shown at step 104. In accordance with the present invention, as discussed above, there is provided an apex locator comprising: a software operated microcontroller having a pulse generator, a memory and an analog to digital converter (ADC), the pulse generator feeding pulses to a gain control circuit for controlling the amplitude of the pulses; a driver for receiving signals from the control circuit and feeding the signals to an electrically conductive shaft; an input buffer configured to receive signals from the dental instrument and to feed the signals to the ADC, wherein the signals are converted to digital signals; a data storage unit configured to store the data; and a transmission unit configured to transmit the data from the apex locator to the data storage unit. If desired, the analog signals may be stored without being converted into digital signals.

Then, as shown at step 106, a pulsed signal is transmitted from a leading edge of the dental instrument, via the root canal, to the apex thereof The pulsed signal is transmitted from the root canal apex to the input buffer and to the ADC. The pulsed signal comprises a plurality of waves, such that the length of the waves shortens as the leading edge of the dental instrument approaches the apex of the root canal.

At step 108, the signal is optionally converted to a digital signal indicative of the distance between the leading edge of the dental instrument and the apex of the root canal. The distance is stored in the microcontroller memory and the indicator 38 (FIG. 2) indicates the distance between the leading edge of the dental instrument and the root canal apex.

At step 110, if the signal indicates that the leading edge of the dental instrument has not reached the apex of the root canal then the dental instrument is inserted further into the root canal, as indicated at step 112, and the method proceeds again with steps 106, 108, etc. In this way, the dental instrument is repeatedly inserted further into the root canal, until it reaches the apex thereof

At step 110, if the signal indicates that the leading edge of the dental instrument has reached the apex of the root canal then the method proceeds with step 114, at which the dental instrument is marked at the point therealong which is at the entrance to the root canal. Then, at step 116, the distance between the marked point and the leading edge of the dental instrument is measured to determine the depth of the root canal. Finally, at step 118, the root canal depth measurement is stored on the data storage unit.

The use of analog or digital signal processing (ASP or DSP) technology in accordance with the present invention, together with sophisticated software and short cables, as discussed above, provides an improved system and method for determining and storing a dental root canal depth measurement, such that the measurement can be retrieved at a later date. The system and method of the present invention thus provide a breakthrough in the endodontic field, having many advantages and advanced capabilities. The use of digital signals eliminates problems that occur in known devices which employ analog signals.

The storage capabilities provided by the data storage unit of the present invention enable previously created images and measurements of a dental root canal to be stored and retrieved at a later date, regardless of the type or location of the apex locator used, thus providing the dentist with an accurate measurement of the depth of a dental root canal so that, together with x-rays, he can better plan a patient's future operation and supervise treatment results. The existing and accumulated data within the software may be used during a root canal treatment and may be cross-referenced by the dentist at any time such as, for example, in the event of an insurance claim.

It is expected that during the life of this patent many relevant systems and/or methods for measuring the depth of a dental root canal will be developed and the scope of the term “apex locator” is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1-45. (canceled)

46. A system for determining and storing a dental root canal depth measurement comprising:
at least one electronic apex locator configured to locate the apex of a dental root canal;
a dental instrument, associated with each of the at least one electronic apex locator, configured to be inserted into the dental root canal, up to the apex thereof; and
a remotely located data storage unit configured for storing data concerning at least one dental root canal, said apex locator configured to transmit data concerning the dental root canal to said data storage unit.

47. The system according to claim 46, further comprising a display configured to exhibit data concerning the dental root canal.

48. The system according to claim 47, wherein the exhibited data includes the distance of a leading edge of said dental instrument from the root canal apex.

49. The system according to claim 47, wherein the exhibited data includes the dental root canal depth measurement.

50. The system according to claim 46, wherein said dental instrument is provided with a marker configured to mark the depth of the root canal along said dental instrument.

51. The system according to claim 50, wherein said marked dental instrument is configured to facilitate the suitability for a root canal treatment of a plurality of additional dental instruments having different thicknesses.

52. The system of claim 50, further comprising a measuring device configured to determine the depth measurement of the dental root canal based on said marked dental instrument.

53. The system of claim 52, wherein the depth measurement is determined based on a measurement of said marked dental instrument.

54. The system of claim 52, wherein said data storage unit is provided with an input device configured for receiving and storing data regarding the depth measurement.

55. The system according to claim 46, wherein said apex locator includes a transmission unit configured for transmitting data concerning the dental root canal to said data storage unit.

56. The system according to claim 55, wherein the data transmitted from said apex locator to said data storage unit includes a measurement of the distance between a leading edge of the dental instrument and the apex of the root canal.

57. The system according to claim 55, wherein the data transmitted from said apex locator to said data storage unit includes data concerning the physical condition of the interior of the root canal.

58. The system according to claim 55, wherein said transmission unit is a wireless transmission unit.

59. The system according to claim 58, wherein said transmission unit is a Bluetooth® transmission unit configured for transmitting the location of a leading edge of said dental instrument.

60. The system according to claim 46, wherein said apex locator is provided with an indicator configured to indicate the distance between a leading edge of said dental instrument and the apex of the root canal.

61. The system according to claim 46, wherein said apex locator is provided with an alarm configured to sound an alarm when a leading edge of said dental instrument is located at the apex of the dental root canal.

62. The system according to claim 46, wherein said apex locator comprises:
a software operated microcontroller having a pulse generator and a memory, said pulse generator being configured to feed pulses to a gain control circuit for controlling the amplitude of said pulses; and
a driver configured to receive signals from said control circuit and to feed said signals to an electrically conductive shaft and a dental instrument having a leading edge.

63. The system according to claim 46, wherein said apex locator comprises:
a software operated microcontroller having a pulse generator, a memory and an analog to digital converter (ADC), said pulse generator being configured to feed pulses to a gain control circuit for controlling the amplitude of said pulses;
a driver configured to receive signals from said control circuit and to feed said signals to an electrically conductive shaft and a dental instrument having a leading edge; and
an input buffer configured to receive signals from said dental instrument and to feed said signals to said ADC, wherein said signals are converted to digital signals.

64. The system according to claim 62, wherein said pulse generator is configured to produce micro-electrical signals at multiple frequencies and to send said signals through said dental instrument to the end of the root canal.

65. The system according to claim 64, wherein said microcontroller is configured to process the output of said multiple frequencies to determine the distance between a leading edge of said dental instrument and the apex of the root canal.

66. The system according to claim 62, wherein said apex locator is configured to determine the physical condition of the interior of the dental root canal.

67. The system according to claim 66, wherein said apex locator is configured to determine the physical condition of the interior of the dental root canal based on a measure of the humidity therein.

68. The system according to claim 67, wherein said microcontroller is configured to automatically adjust the impedance of current transmitted via said dental instrument such that it corresponds to the physical condition of the interior of the dental root canal.

69. A method for determining and storing a dental root canal depth measurement comprising:
(a) providing a dental instrument having a leading edge;
(b) inserting said dental instrument into the beginning of the root canal;
(c) transmitting a pulsed signal from said dental instrument, via the root canal, to the apex of the root canal;
(d) converting said pulsed signal to a signal indicative of the distance between a leading edge of said dental instrument and the apex of the root canal;
(e) if said indicative signal indicates that said leading edge of said dental instrument has reached the apex of the root canal then proceeding to step (g), otherwise proceeding to step (f);
(f) inserting said dental instrument further into the root canal and returning to step (c);
(g) marking said dental instrument at the point therealong which is at the entrance to the root canal;
(h) measuring the distance between said marked point and said leading edge of said dental instrument to determine the depth of the root canal; and
(i) storing the root canal depth measurement.

70. A method according to claim 69, wherein said pulsed signal comprises a plurality of waves wherein the length of the waves shortens as said leading edge of said dental instrument approaches the apex of the root canal.
